(19) United States
(12) Patent Application Publication
(10) Pub. No.: US 2022/0269991 A1
(43) Pub. Date: Aug. 25, 2022

(54) EVALUATING RELIABILITY OF ARTIFICIAL INTELLIGENCE

(71) Applicant: Truera, Inc., Redwood City, CA (US)

(72) Inventors: David Sandai Kurokawa, Kirkland, WA (US); Shayak Sen, San Mateo, CA (US); Anupam Datta, Redwood City, CA (US)

(21) Appl. No.: 17/673,388

(22) Filed: Feb. 16, 2022

Related U.S. Application Data
(60) Provisional application No. 63/150,265, filed on Feb. 17, 2021.

(51) Int. Cl. G06N 20/00

(52) U.S. Cl. CPC G06N 20/00

(57) ABSTRACT

Computer accesses training dataset with plurality of datapoints, each datapoint having input vector of feature values and output value. Training dataset is for training machine learning engine to predict the output value based on the input vector of feature values. The computer stores the training dataset as a two-dimensional vector with rows representing datapoints and columns representing features. The computer computes, for each feature value, a QII (quantitative input influence) value measuring a degree of influence that the feature exerts on the output value. For each datapoint from at least a subset of the plurality of datapoints, the computer (i) determines whether the QII value for each feature value in the input vector is within a predefined range, and (ii) upon determining that the QII value for a given feature value in the input vector is not within the predefined range: adjusts the training dataset or the machine learning engine.

### CROSS-REFERENCE TO RELATED APPLICATIONS

This application claims the benefit of U.S. Provisional Patent No. 63/150,265, filed Feb. 17, 2021, and entitled “Evaluating Reliability of Artificial Intelligence.” This provisional application is herein incorporated by reference in its entirety.

### TECHNICAL FIELD

Embodiments pertain to computer architecture. Some embodiments relate to artificial intelligence. Some embodiments relate to evaluating reliability of artificial intelligence.

### BACKGROUND

Some artificial intelligence schemes are more reliable at making classifications or decisions than others. Techniques for identifying the most reliable artificial intelligence schemes may be desirable.

### BRIEF DESCRIPTION OF THE DRAWINGS

Various of the appended drawings merely illustrate example embodiments of the present disclosure and cannot be considered as limiting its scope.

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 illustrates an example plot showing feature values on the horizontal axis and the influence associated with that feature value on the vertical axis, in accordance with some embodiments.

FIG. 7 is a flow chart of an example preprocessing process for evaluating reliability of artificial intelligence based on quantitative input influence value, in accordance with some embodiments.

FIG. 8 is a flow chart of an example preprocessing process for evaluating reliability of artificial intelligence based on normalized quantitative input influence value, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Aspects of the present invention may be implemented as part of a computer system. The computer system may be one physical machine, or may be distributed among multiple physical machines, such as by role or function, or by process thread in the case of a cloud computing distributed model. In various embodiments, aspects of the invention may be configured to run in virtual machines that in turn are executed on one or more physical machines. It will be understood by persons of skill in the art that features of the invention may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations and should generally not be limited to any particular implementation exemplified herein, unless such limitations are expressly called out.

In addition, an engine may itself be composed of more than one sub-engine, and each sub-engine may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

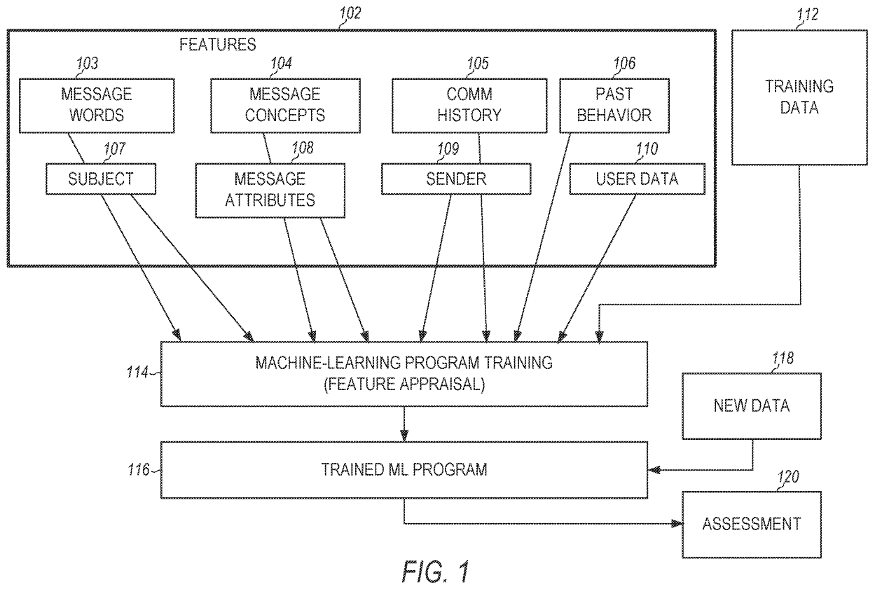

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the models are evaluated, and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that is has not been trained on. In a second example, a false positive rate or false negative rate may be used to evaluate the models after finalization. In a third example, a delineation between data clusterings is used to select a model that produces the clearest bounds for its clusters of data.

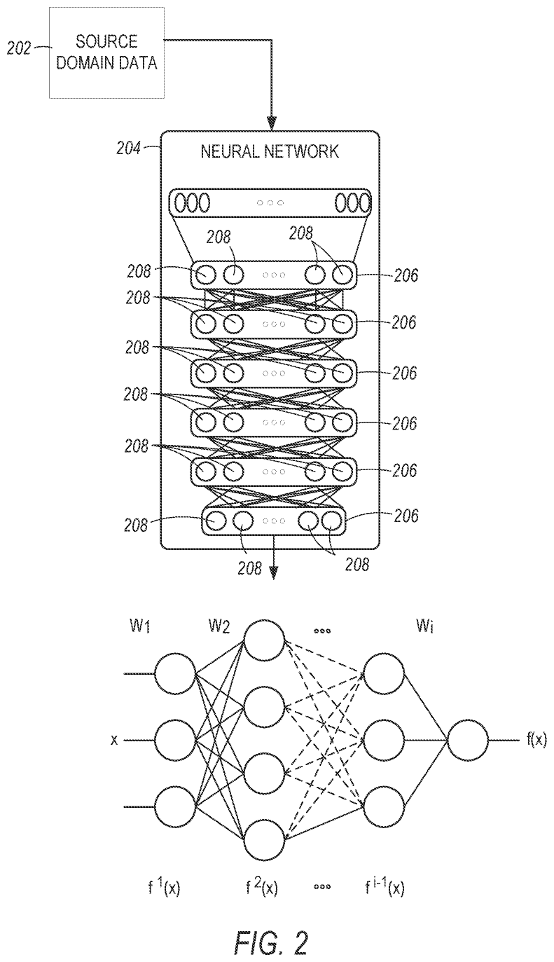

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , f^{t-1}(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

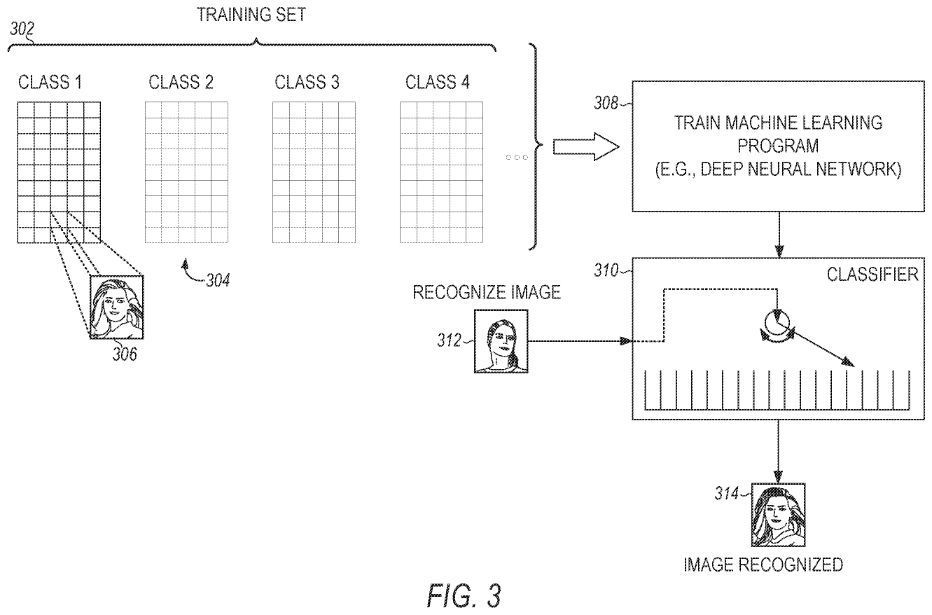

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Barack Obama, one class corresponds to George W. Bush, one class corresponds to Bill Clinton, etc.). At block 308 the machine learning program is trained, for example, using a deep neural network. At block 310, the trained classifier, generated by the training of block 308, recognizes an image 312, and at block 314 the image is recognized. For example, if the image 312 is a photograph of Bill Clinton, the classifier recognizes the image as corresponding to Bill Clinton at block 314.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

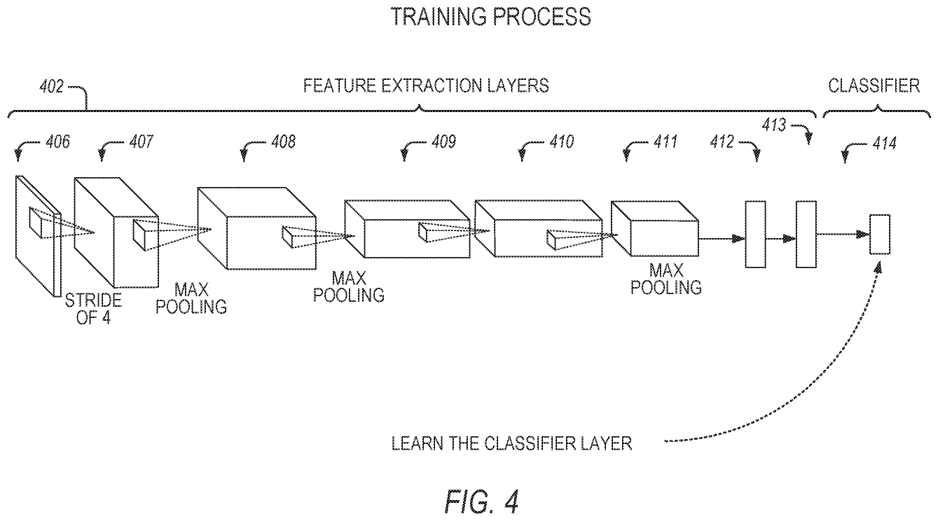

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face-identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as be reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

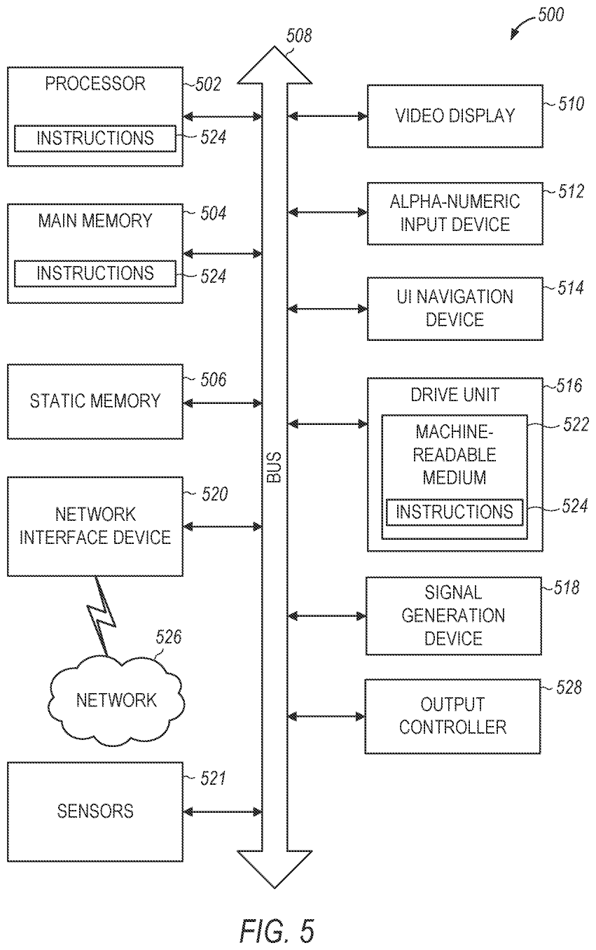

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

This document presents, among other things, a system and method for assessing the reliability of model predictions. Given an artificial intelligence model and an input for which the model may provide a prediction, the system and method assess the reliability of the model for this particular input.

The system and method are related, among other things, to the general problem of representation: a data point that is supplied as input to a model may not be well represented in the training data that was used to create the model. In this case, limitations in the training data lead to limitations in the model derived from it. Regardless of how the model is derived from the data, the model will not have a meaningful basis to provide accurate output.

Some embodiments consider two ways that training data may be insufficient for a particular model input—outliers and high sensitivity. After a point is identified as an outlier (e.g., using any outlier identification technique), some embodiments are directed to the model's treatment of the point(s) identified as outlier(s) (e.g., as captured by feature influences). In some cases, predictions based on point(s) identified as outlier(s) may be less reliable than predictions based on non-outlier point(s).

A second form of insufficiency occurs when the model output depends on only a few data features. This results in high sensitivity: the model output is highly sensitive to any variations in those few features. This is not a robust condition for model prediction.

In the system and method for assessing the reliability of model predictions, outliers and high sensitivity are identified based on feature influence. This is an approach that leads to better performance than prior approaches that do not utilize feature influence.

The system and method are based on the operations in Table 1, addressing the representation problem associated with outliers (step 2b) and insufficient relevant factors (step 2c).

TABLE 1
Steps in Representation Problems Associated with Outliers

```
1. Input: Model, point
2. System and Method:
  a. Determine the relative influence of features used in model
    prediction.
      i. This may be done by several different methods, including
        Shapley value methods as one class of illustrative
        examples.
  b. Identifying outliers in the feature influence values (rather than
    the feature values) using a set of methods that include but are not
    limited to:
      i. Outlier detection algorithms
      ii. Overinfluence identification using influence sensitivity
        plots
      iii. Influence restriction based on outlierness
    Mitigation techniques correspond to the way in which undue
influence is detected.
  c. Assess whether a model prediction is highly sensitive to changes
    in a few features
      i. Using methods that include influence L2 norms, such as the
        QII L2 norm. Mitigation techniques include moving
        predictions closer to the median, mean or any central point
        of the score, for example.
```

Representation can be assessed based on how various features influence model prediction. Typical methods for determining feature influence around a given input point will compute influence as model inputs vary. For example, Quantitative Input Influence (QII) computes feature influence for a sample of data points in the training data set. The general method of computing QII is described as an illustrative example.

QII measures the degree of influence that each input feature exerts on the outputs of the system. There are several variants of QII. Unary QII computes the difference in outputs arising from two related input distributions—the real distribution and a hypothetical (or counterfactual) distribution that is constructed from the real distribution to account for correlations among inputs. Unary QII can be generalized to a form of joint influence of a set of inputs, called Set QII. A third method defines Marginal QII, which measures the difference in output based on comparing training data with and without the specific input whose marginal influence some embodiments want to measure. Depending on the application, some embodiments may choose the training sets the embodiments compare in different ways, leading to several different variants of Marginal QII.

Some embodiments relate to outlier detection. Outliers can be detected by training a secondary model whose purpose is to predict whether a specific point is an outlier, also called an anomaly in this context. In other words, this approach trains an anomaly detector on the training data and uses the resulting anomaly detector to determine if a new point is likely to be most closely related to outliers in the data. This technique can be carried out using single class SVMs (support vector machines), isolation forests, and other forms of secondary models (i.e., anomaly detectors). An advantage of training an anomaly detector is that this approach is based directly on the training data and does not depend on the behavior of the primary model.

Broad categories of techniques for training the anomaly detector include the following.

Unsupervised anomaly detection techniques that detect outliers in an unlabeled test data set under the assumption that the majority of the instances in the data set are normal by looking for instances that seem to fit least to the remainder of the data set.

Supervised anomaly detection techniques that detect outliers in a data set that has been labeled as “normal” and “abnormal.” With labelled data, some embodiments train a classifier to identify outliers. One key difference with many other statistical classification problems is the inherent unbalanced nature of outlier detection. Thus, training a classifier must be done with specific attention to balance.

Semi-supervised detection techniques construct a model representing normal behavior from a given normal training data set, and then test the likelihood of a test instance to be generated by the model that characterizes the normal “non-outliers.”

Some embodiments relate to overinfluence identification through influence sensitivity plots. Influence sensitivity plots are a graphical method that can be used to visualize when outliers may affect model output in an undesirable way. This can be understood by example. The following plot shows feature values on the horizontal axis and the influence associated with that feature value on the vertical axis.

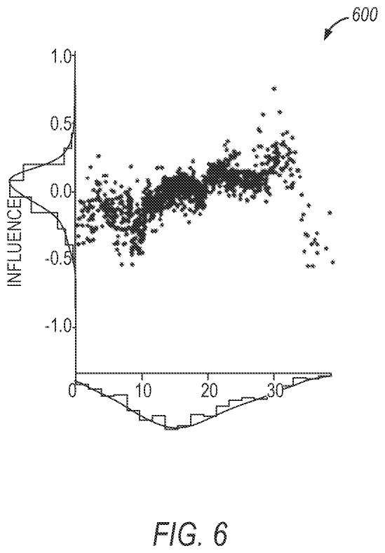

FIG. 6 illustrates an example plot 600 showing feature values on the horizontal axis and the influence associated with that feature value on the vertical axis, in accordance with some embodiments. For most of the data values shown, the influence increases slightly in the positive direction as the feature value increases. This is shown in the illustration for feature values from the left end of the plot through a feature value of approximately 30. However, as the feature value increases above 30-32 the influence suddenly shifts from the positive range of 0 to 0.5 into negative territory. However, there are few points in this region—a few points with feature value above 32. As a result, it is apparent that for the sudden negative influence for feature values above 32, the data that are causing the negative influence are outliers.

Mitigation can be based on feature influence. Because influence sensitivity plots identify the feature ranges of outliers, these outliers can be identified in the training data and replaced by techniques similar to missing data. For example, their feature values can be replaced with the mean, mode or median value. More complicated techniques include Winsorizing—replacing extreme values with minimum and maximum percentiles—and discretization (binning)—dividing the range of the variable into discrete groups and recording only a numerical value associated with the group. Each of these methods replaces an extreme value with one in a more common range, while still approximating the original data. That might be preferable to simply using a mean, mode or median value.

Some embodiments relate to influence restriction based on outlierness, which is a combined detection and mitigation method that addresses undue influence by restricting the influence of any feature. This method may restrict the influence of any feature to a selected range. In this document, the term “outlierness” may refer, among other things, to the degree to which a point is an outlier, when feature influence is considered.

One way of approaching outlierness is to restrict the QII of each individual feature to a range of values. For example, the feature value could be restricted to values in the 1^{st} to 99^{th} percentile of that feature's QIIs in the training set. The method for doing this computes the percentile ranges in the training set and then modifies values outside that range. For example, a feature with influence above the 99^{th} percentile is reduced to the maximum value below this upper limit. This method directly adjusts the model so that it does not rely on extreme QII values for any feature to make any decision. After influence restriction, it is appropriate to recompute the scores accordingly so that the sum of the QIIs of each feature will sum to the score with an offset.

According to some embodiments, one of the properties of QII is that the influences add up to the score minus the mean score of some base distribution.

$${s}^{i} = \overline{s} + {\sum }_{f} {q}_{f}^{i}$$

In the above equation, sⁱ is the model score at point instance i, s̅ is the mean of the model score over a set of instances or “base distribution,” and q_{f}ⁱ is the influence (on the model score) of the feature f at instance i.

The QII outlierness reliability metric qii_clipping is the qii-clipped adjustment to the score at instance i. The qii_clipping is given by limiting the influence of each feature to a δ percentile, where the lower bound of the influence is given by q_{f,δ} and the upper bound is given by q_{f,1-δ}:

$$qii\_clipping ( {\vec{q}}^{i} ) = \overline{s} + {\sum }_{f} min ( max ( {q}_{f}^{i} , {q}_{f , δ} ) , {q}_{f , 1 - δ} )$$

In the above equation, \vec{q}ⁱ is a vector of influences (each element is an influence of a feature) at instance i, and \vec{q}ⁱ is equal to <q_{f}_{₁}ⁱ, q_{f}_{₂}ⁱ . . . > for features f₁, f₂, . . . .

Some embodiments relate to a system based on outliers. To compute this clipping value, some embodiments have the QIIs of the data point which is to be “clipped,” along with a set of QII values for several other data points. This set of points may be of size at least 1000 (or another minimum threshold size). Some embodiments can then take these two inputs and produce a single numerical value representing the “clipped” value of the provided data point.

The computation itself may take the QIIs in the form of a pandas DataFrame (akin to a matrix) where the columns represent the features of the model and the rows represent data points for which the QIIs have been computed. Some embodiments then take for each column the 1^{st} and 99^{th} percentiles (or similar values such as 0.1^{th} and 99.9^{th} percentiles). Some embodiments then take the QII values for the provided data point which some embodiments clip and ensure that for each feature, the QII value of the point is no lower than the 1^{st} percentile (or whatever low percentile was used) computed previously. If it is, some embodiments replace the value with the 1^{st} percentile. Similarly, some embodiments ensure the QII value is no higher than the 99^{th} percentile (or whatever high percentile was used). This can be done in a vectorized way if using Python's numpy or pandas libraries and can be done the classic iterative way otherwise. Some embodiments finish by summing the resulting “clipped” QII values and subtracting the offset. As none of these computations are extremely computationally expensive, this entire calculation may be done using nearly any computer.

Some embodiments relate to techniques based on high sensitivity and overreliance on a small number of features. Some embodiments relate to influence L2 norms.

The vector of influences associated with an input point can be used to calculate a norm that will indicate whether a small number of features are used in the model prediction for this point. One specific measure that is easily calculated from the vector of influence values is the influence L2 norm. The L2 norm, a mathematical concept in the study of vector spaces, is the sum of squares of the values of the vector. Mathematically, the QII L2 reliability metric qii_l2 for a point i is given by simply the L2 norm of the QII values \vec{q}ⁱ.

$$qii\_l2 ( {\vec{q}}^{i} ) = \sqrt{{\sum }_{f} {( {q}_{f}^{i} )}^{2}}$$

To give a simple example, the norm of the vector (1,1,1) is sqrt(1²+1²+1²)=sqrt(3). In comparison, the norm of (0,0,3) is sqrt(3²)=3. For two vectors whose components sum to the same total (as is the case for influence vectors), a vector with a few large values will have a significantly higher L2 norm than a vector with more even values throughout.

A high qii_l2 value is therefore correlated with overreliance: the model relies on a few features rather than a large group of features. In the case of the influence vectors (1, 1, 1) vs (0, 0, 3) the former relies on all three features equally to arrive at its decision, whereas the latter uses only the third feature. High reliance on relatively few features can suggest susceptibility to changing trends and noise such as in cases listed in Table 2.

TABLE 2
Cases with high reliance on few features

```
1. If the relationship between the output and the highly influential
  features changes then the model may become obsolete.
    a. As an example of this, consider the case where the model
      estimates whether a mortgage applicant might default when
      given the three features of previous week's income, previous
      months' income, and the previous year's income. A model that
      relies only on the last feature would be quite susceptible to
      Covid-19 like events.
2. Randomness/imperfectness of the training procedure or data gathering
  can be far more pronounced in the model.
    a. As an example of this, consider the case where the model
      estimates the current weight of an individual given weightings
      three days ago, two days ago, and yesterday. A model that relies
      only on the last feature would be quite susceptible to a situation
      where the scale happened to malfunction yesterday.
```

More technically, this qii_l2 metric is proportional to the standard deviation of the score sunder certain assumptions on the QII/influence vectors. Specifically, suppose the QII value for feature f is a random variable with standard deviation cq_{f} (for some c≥0) and that these random variables are all independent. Then since:

$${s}^{i} = \overline{s} + {\sum }_{f} {q}_{f}$$

The variance V[s] of s is:

$$V [ s ] = V [ \overline{s} + {\sum }_{f} {q}_{f} ] = V [ \overline{s} ] + {\sum }_{f} V [ {q}_{f} ] = 0 + {\sum }_{f} {( {cq}_{f} )}^{2} = {c}^{2} {\sum }_{f} {( {q}_{f} )}^{2}$$

Based on the above, the standard deviation of s is c·qii_l2(q).

Mitigation can be based on feature influence. In particular, remediation based on L2 norm can effectively reduce overreliance. Estimating a value for c≥0 as above, remediation can move the predictions closer to the median, mean, or any central point m of the score. For example, m can be the median of the model scores on the training data. That is, if c is known, under the assumption, the true score/probability of x should be likely within two standard deviations (i.e., 2c|q|2) of s. Thus, some embodiments may try replacing s with either min(m, s+2c|q|_2) or max(m, s−2c|q|_2)—whichever is further from m. (It is noted that at most one can be not m.)

In some embodiments, this approach can indeed improve and “robustify” the model and therefore empirically show that the metric may work well in practice.

Some embodiments relate to system based on high sensitivity.

To compute this L2 value, some embodiments input only the QIIs of the data point and estimate the standard deviation of the score an estimate for the value c. Alternatively, some embodiments can estimate c via examining the data and model or simply choosing a sensible value for it. Some embodiments can then take these and produce a single numerical value representing the L2 value of the provided data point and another representing an estimate of the standard deviation.

Computing the L2 value itself involves taking the QIIs in the form of a vector, squaring each entry, summing these squared values, and square rooting the final result. Once c is known (as in the case where it is supplied and/or given a sensible value such as 0.05) some embodiments compute the standard deviation estimate via multiplying c to this value. If some embodiments compute the informed estimate of c, some embodiments can take many quantities such as: (i) the standard deviation of the model score in general over the training data points, (ii) the mean of the standard deviations of each feature's QII values for the training data points, and (iii) the mean of the standard deviations of each feature's QII values for the provided point if the feature in question were perturbed slightly.

Some aspects include one or more of the following features: (i) determining the relative influence of features, (ii) determining outliers in feature values is in the prior art, (iii) determining outliers based on feature influence and using that to assess the reliability of model predictions, (iv) assessing whether a model prediction is highly sensitive to changes in a few features using methods based on feature influence, and (v) mitigation methods based on feature influence.

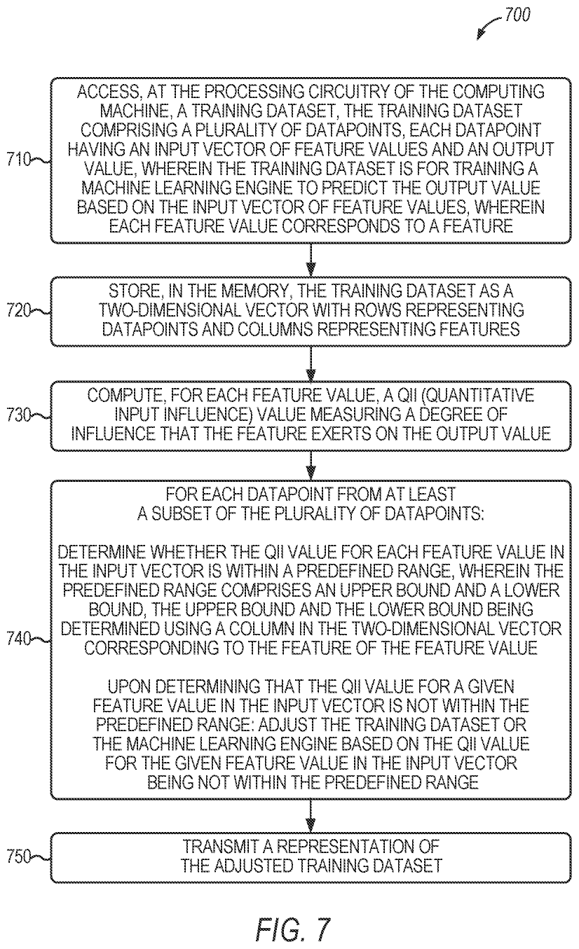

FIG. 7 is a flow chart of an example preprocessing process 700 for evaluating reliability of artificial intelligence based on quantitative input influence value, in accordance with some embodiments. In some implementations, one or more process blocks of FIG. 7 may be performed by a computing machine (e.g., computing machine 500). In some implementations, one or more process blocks of FIG. 7 may be performed by another device or a group of devices separate from or including the computing machine. Additionally, or alternatively, one or more process blocks of FIG. 7 may be performed by one or more components of the computing machine 500 shown in FIG. 5.

As shown in FIG. 7, process 700 may include accessing, at the processing circuitry of the computing machine, a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature (block 710). For example, the computing machine may access a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature, as described above.

As further shown in FIG. 7, process 700 may include storing, in the memory, the training dataset as a two-dimensional vector with rows representing datapoints and columns representing features (block 720). For example, the computing machine may store, in the memory, the training dataset as a two-dimensional vector with rows representing datapoints and columns representing features, as described above.

As further shown in FIG. 7, process 700 may include computing, for each feature value, a QII (quantitative input influence) value measuring a degree of influence that the feature exerts on the output value (block 730). For example, the computing machine may compute, for each feature value, a QII (quantitative input influence) value measuring a degree of influence that the feature exerts on the output value, as described above.

As further shown in FIG. 7, process 700 may include for each datapoint from at least a subset of the plurality of datapoints: determining whether the QII value for each feature value in the input vector is within a predefined range, wherein the predefined range comprises an upper bound and a lower bound, the upper bound and the lower bound being determined using a column in the two-dimensional vector corresponding to the feature of the feature value: and upon determining that the QII value for a given feature value in the input vector is not within the predefined range: adjusting the training dataset or the machine learning engine based on the QII value for the given feature value in the input vector being not within the predefined range (block 740). For example, the computing machine may for each datapoint from at least a subset of the plurality of datapoints: determine whether the QII value for each feature value in the input vector is within a predefined range, wherein the predefined range comprises an upper bound and a lower bound, the upper bound and the lower bound being determined using a column in the two-dimensional vector corresponding to the feature of the feature value. Upon determining that the QII value for a given feature value in the input vector is not within the predefined range: the computing machine may adjust the training dataset or the machine learning engine based on the QII value for the given feature value in the input vector being not within the predefined range, as described above.

As further shown in FIG. 7, process 700 may include transmitting a representation of the adjusted training dataset (block 750). For example, the computing machine may transmit a representation of the adjusted training dataset, as described above.

Process 700 may include additional implementations, such as any single implementation or any combination of implementations described below and/or in connection with one or more other processes described elsewhere herein.

In a first implementation, adjusting the training dataset or the machine learning engine comprises adjusting the given feature value in the input vector to place the QII value into the predefined range.

In a second implementation, adjusting the training dataset or the machine learning engine comprises reducing, in the machine learning engine, an influence, on a predicted output value, of the given feature value in the input vector when the QII value is not within the predefined range.

In a third implementation, process 700 includes computing, for a plurality of feature values in the input vector, including the given feature value, a normalized QII value, and if the normalized QII value exceeds a threshold readjusting the training dataset or the machine learning engine to reduce the normalized QII value.

In a fourth implementation, the normalized QII value is computed as a square root of a sum of the squares of the QII values for each of the plurality of features in the input vector.

In a fifth implementation, process 700 includes training, using the training dataset with the adjusted input vectors, the machine learning engine to predict the output value based on the input vector of feature values.

In a sixth implementation, training the machine learning engine comprises supervised learning, unsupervised learning or reinforcement learning.

In a seventh implementation, the QII comprises a unary QII computed based on difference in output value arising from differences in input value distributions.

In an eighth implementation, the unary QII takes into account a joint influence of a plurality of input values.

In a ninth implementation, the QII comprises a marginal QII based on comparing the training dataset with and without a specific feature value.

In a tenth implementation, process 700 includes detecting an outlier datapoint having an outlier input vector of feature values relative to the training dataset, and removing the outlier datapoint from the training dataset.

In an eleventh implementation, the predefined range is between a first percentile of QII values in the training dataset and a second percentile of QII values in the training dataset.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

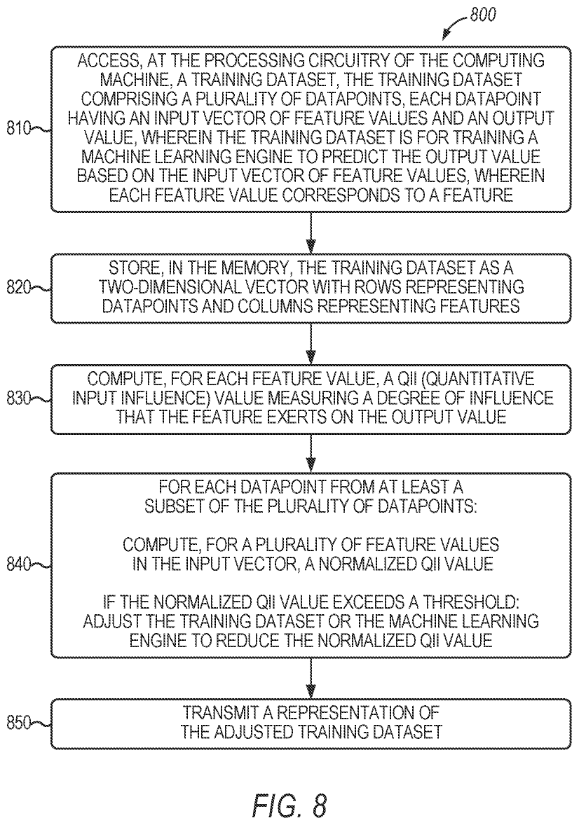

FIG. 8 is a flow chart of an example preprocessing process 800 for evaluating reliability of artificial intelligence based on normalized quantitative input influence value, in accordance with some embodiments. In some implementations, one or more process blocks of FIG. 8 may be performed by a computing machine (e.g., computing machine 500). In some implementations, one or more process blocks of FIG. 8 may be performed by another device or a group of devices separate from or including the computing machine. Additionally, or alternatively, one or more process blocks of FIG. 8 may be performed by one or more one or more components of the computing machine 500 shown in FIG. 5. It should be noted that the process 700 of FIG. 7 and the process 800 of FIG. 8 may be performed by different computing machines or, alternatively, by the same computing machine.

As shown in FIG. 8, process 800 may include accessing, at the processing circuitry of the computing machine, a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature (block 810). For example, the computing machine may access a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature, as described above.

As further shown in FIG. 8, process 800 may include storing, in the memory, the training dataset as a two-dimensional vector with rows representing datapoints and columns representing features (block 820). For example, the computing machine may store, in the memory, the training dataset as a two-dimensional vector with rows representing datapoints and columns representing features, as described above.

As further shown in FIG. 8, process 800 may include computing, for each feature value, a QII (quantitative input influence) value measuring a degree of influence that the feature exerts on the output value (block 830). For example, the computing machine may compute, for each feature value, a QII (quantitative input influence) value measuring a degree of influence that the feature exerts on the output value, as described above.

As further shown in FIG. 8, process 800 may include for each datapoint from at least a subset of the plurality of datapoints: computing, for a plurality of feature values in the input vector, a normalized QII value; and if the normalized QII value exceeds a threshold: adjusting the training dataset or the machine learning engine to reduce the normalized QII value (block 840). For example, the computing machine may for each datapoint from at least a subset of the plurality of datapoints: compute, for a plurality of feature values in the input vector, a normalized QII value. If the normalized QII value exceeds a threshold: the computing machine may adjust the training dataset or the machine learning engine to reduce the normalized QII value, as described above.

As further shown in FIG. 8, process 800 may include transmitting a representation of the adjusted training dataset (block 850). For example, the computing machine may transmit a representation of the adjusted training dataset, as described above.

Process 800 may include additional implementations, such as any single implementation or any combination of implementations described below and/or in connection with one or more other processes described elsewhere herein.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

Some embodiments are described as numbered examples (Example 1, 2, 3, etc.). These are provided as examples only and do not limit the technology disclosed herein.

Example 1 is a method implemented at a computing machine comprising processing circuitry and memory, the method comprising: accessing, at the processing circuitry of the computing machine, a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature; storing, in the memory, the training dataset as a two-dimensional vector with rows representing datapoints and columns representing features: computing, for each feature value, a QII (quantitative input influence) value measuring a degree of influence that the feature exerts on the output value; for each datapoint from at least a subset of the plurality of datapoints: determining whether the QII value for each feature value in the input vector is within a predefined range, wherein the predefined range comprises an upper bound and a lower bound, the upper bound and the lower bound being determined using a column in the two-dimensional vector corresponding to the feature of the feature value; and upon determining that the QII value for a given feature value in the input vector is not within the predefined range: adjusting the training dataset or the machine learning engine based on the QII value for the given feature value in the input vector being not within the predefined range; and transmitting a representation of the adjusted training dataset.

In Example 2, the subject matter of Example 1 includes, wherein adjusting the training dataset or the machine learning engine comprises: adjusting the given feature value in the input vector to place the QII value into the predefined range.

In Example 3, the subject matter of Examples 1-2 includes, wherein adjusting the training dataset or the machine learning engine comprises: reducing, in the machine learning engine, an influence, on a predicted output value, of the given feature value in the input vector when the QII value is not within the predefined range.

In Example 4, the subject matter of Examples 1-3 includes, computing, for a plurality of feature values in the input vector, including the given feature value, a normalized QII value; and if the normalized QII value exceeds a threshold: readjusting the training dataset or the machine learning engine to reduce the normalized QII value.

In Example 5, the subject matter of Example 4 includes, wherein the normalized QII value is computed as a square root of a sum of the squares of the QII values for each of the plurality of features in the input vector.

In Example 6, the subject matter of Examples 1-5 includes, training, using the training dataset with the adjusted input vectors, the machine learning engine to predict the output value based on the input vector of feature values.

In Example 7, the subject matter of Example 6 includes, wherein training the machine learning engine comprises supervised learning, unsupervised learning or reinforcement learning.

In Example 8, the subject matter of Examples 1-7 includes, wherein the QII comprises a unary QII computed based on difference in output value arising from differences in input value distributions.

In Example 9, the subject matter of Example 8 includes, wherein the unary QII takes into account a joint influence of a plurality of input values.

In Example 10, the subject matter of Examples 1-9 includes, wherein the QII comprises a marginal QII based on comparing the training dataset with and without a specific feature value.

In Example 11, the subject matter of Examples 1-10 includes, detecting an outlier datapoint having an outlier input vector of feature values relative to the training dataset; and removing the outlier datapoint from the training dataset.

In Example 12, the subject matter of Examples 1-11 includes, wherein the predefined range is between a first percentile of QII values in the training dataset and a second percentile of QII values in the training dataset.

Example 13 is a method implemented at a computing machine comprising processing circuitry and memory, the method comprising: accessing, at the processing circuitry of the computing machine, a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature; storing, in the memory, the training dataset as a two-dimensional vector with rows representing datapoints and columns representing features; computing, for each feature value, a QII (quantitative input influence) value measuring a degree of influence that the feature exerts on the output value; for each datapoint from at least a subset of the plurality of datapoints: computing, for a plurality of feature values in the input vector, a normalized QII value; and if the normalized QII value exceeds a threshold: adjusting the training dataset or the machine learning engine to reduce the normalized QII value; and transmitting a representation of the adjusted training dataset.

Example 14 is at least one machine-readable medium including instructions that, when executed by processing circuitry, cause the processing circuitry to perform operations to implement of any of Examples 1-13.

Example 15 is an apparatus comprising means to implement of any of Examples 1-13.

Example 16 is a system to implement of any of Examples 1-13.

Example 17 is a method to implement of any of Examples 1-13.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method implemented at a computing machine comprising processing circuitry and memory, the method comprising:
accessing, at the processing circuitry of the computing machine, a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature;
storing, in the memory, the training dataset as a two-dimensional vector with rows representing datapoints and columns representing features;
computing, for each feature value, a QII (quantitative input influence) value measuring a degree of influence that the feature exerts on the output value;
for each datapoint from at least a subset of the plurality of datapoints:
determining whether the QII value for each feature value in the input vector is within a predefined range, wherein the predefined range comprises an upper bound and a lower bound, the upper bound and the lower bound being determined using a column in the two-dimensional vector corresponding to the feature of the feature value; and
upon determining that the QII value for a given feature value in the input vector is not within the predefined range: adjusting the training dataset or the machine learning engine based on the QII value for the given feature value in the input vector being not within the predefined range; and
transmitting a representation of the adjusted training dataset.

2. The method of claim 1, wherein adjusting the training dataset or the machine learning engine comprises:
adjusting the given feature value in the input vector to place the QII value into the predefined range.

3. The method of claim 1, wherein adjusting the training dataset or the machine learning engine comprises:
reducing, in the machine learning engine, an influence, on a predicted output value, of the given feature value in the input vector when the QII value is not within the predefined range.

4. The method of claim 1, further comprising:
computing, for a plurality of feature values in the input vector, including the given feature value, a normalized QII value; and
if the normalized QII value exceeds a threshold: readjusting the training dataset or the machine learning engine to reduce the normalized QII value.

5. The method of claim 4, wherein the normalized QII value is computed as a square root of a sum of the squares of the QII values for each of the plurality of feature values in the input vector.

6. The method of claim 1, further comprising:
training, using the training dataset with the adjusted input vectors, the machine learning engine to predict the output value based on the input vector of feature values.

7. The method of claim 6, wherein training the machine learning engine comprises supervised learning, unsupervised learning or reinforcement learning.

8. The method of claim 1, wherein the QII comprises a unary QII computed based on difference in output value arising from differences in input value distributions.

9. The method of claim 8, wherein the unary QII takes into account a joint influence of a plurality of input values.

10. The method of claim 1, wherein the QII comprises a marginal QII based on comparing the training dataset with and without a specific feature value.

11. The method of claim 1, further comprising:
detecting an outlier datapoint having an outlier input vector of feature values relative to the training dataset; and
removing the outlier datapoint from the training dataset.

12. The method of claim 1, wherein the predefined range is between a first percentile of QII values in the training dataset and a second percentile of QII values in the training dataset.

13. A method implemented at a computing machine comprising processing circuitry and memory, the method comprising:
accessing, at the processing circuitry of the computing machine, a training dataset, the training dataset comprising a plurality of datapoints, each datapoint having an input vector of feature values and an output value, wherein the training dataset is for training a machine learning engine to predict the output value based on the input vector of feature values, wherein each feature value corresponds to a feature;
storing, in the memory, the training dataset as a two-dimensional vector with rows representing datapoints and columns representing features;
computing, for each feature value, a QII (quantitative input influence) value measuring a degree of influence that the feature exerts on the output value;
for each datapoint from at least a subset of the plurality of datapoints:
computing, for a plurality of feature values in the input vector, a normalized QII value; and
if the normalized QII value exceeds a threshold: adjusting the training dataset or the machine learning engine to reduce the normalized QII value; and
transmitting a representation of the adjusted training dataset.

14. A tangible machine-readable storage medium including instructions that, when executed by a machine, cause the machine to perform operations comprising:
accessing a training dataset comprising a plurality of datapoints, each datapoint having an input vector of feature values and an output value, wherein the training dataset is for training a machine learning engine to predict the output value based on the input vector of feature values, wherein each feature value corresponds to a feature;
storing the training dataset as a two-dimensional vector with rows representing datapoints and columns representing features;
computing, for each feature value, a QII (quantitative input influence) value measuring a degree of influence that the feature exerts on the output value;
for each datapoint from at least a subset of the plurality of datapoints:
determining whether the QII value for each feature value in the input vector is within a predefined range, wherein the predefined range comprises an upper bound and a lower bound, the upper bound and the lower bound being determined using a column in the two-dimensional vector corresponding to the feature of the feature value; and
upon determining that the QII value for a given feature value in the input vector is not within the predefined range: adjusting the training dataset or the machine learning engine based on the QII value for the given feature value in the input vector being not within the predefined range; and
transmitting a representation of the adjusted training dataset.

15. The tangible machine-readable storage medium as recited in claim 14, wherein adjusting the training dataset or the machine learning engine comprises:
adjusting the given feature value in the input vector to place the QII value into the predefined range.

16. The tangible machine-readable storage medium as recited in claim 14, wherein the machine further performs operations comprising:
computing, for a plurality of feature values in the input vector, including the given feature value, a normalized QII value; and
if the normalized QII value exceeds a threshold: readjusting the training dataset or the machine learning engine to reduce the normalized QII value.

17. The tangible machine-readable storage medium as recited in claim 16, wherein the normalized QII value is computed as a square root of a sum of the squares of the QII values for each of the plurality of feature values in the input vector.

18. The tangible machine-readable storage medium as recited in claim 14, wherein the machine further performs operations comprising:
training, using the training dataset with the adjusted input vectors, the machine learning engine to predict the output value based on the input vector of feature values.

19. The tangible machine-readable storage medium as recited in claim 14, wherein the QII comprises a unary QII computed based on difference in output value arising from differences in input value distributions.

20. The tangible machine-readable storage medium as recited in claim 14, wherein the QII comprises a marginal QII based on comparing the training dataset with and without a specific feature value.
